(19) United States
(12) Patent Application Publication
(10) Pub. No.: US 2026/0154081 A1
(43) Pub. Date: Jun. 4, 2026

(54) SYSTEM EXECUTING PRE-PROCESSING, PROCESSING DEVICE AND OPERATING METHOD OF THE PROCESSING DEVICE

(71) Applicant: SK hynix Inc., Icheon-si (KR)

(72) Inventors: Hui Jae YU, Icheon-si (KR); Jung Hyun JOH, Icheon-si (KR)

(21) Appl. No.: 19/330,610

(22) Filed: Sep. 16, 2025

(30) Foreign Application Priority Data
Dec. 3, 2024 (KR) 10-2024-0177554
Apr. 28, 2025 (KR) 10-2025-0055112

(51) Int. Cl. G06F 9/30

(52) U.S. Cl. CPC G06F 9/30123

(57) ABSTRACT

A system includes a central processing unit; a first processing device; and a second processing device, and the first processing device (i) reads original data from the first memory, (ii) reads pre-processing information from the first base address register, (iii) executes a pre-processing operation on the original data using the pre-processing information to generate result data, and (iv) transmits the result data to second processing device without detouring via an external processor.

### CROSS-REFERENCES TO RELATED APPLICATIONS

The present application claims priorities under 35 U.S.C. § 119(a) to Korean Patent Application Nos. 10-2024-0177554 filed on Dec. 3, 2024 and 10-2025-0055112 filed on Apr. 28, 2025, which are incorporated herein by reference in their entireties.

### BACKGROUND

### 1. Technical Field

Embodiments of the present disclosure relate to a system that executes pre-processing, a processing device, and an operating method of the processing device.

### 2. Related Art

As artificial intelligence technology advances, research is actively being conducted on systems that process various types of data through artificial intelligence.

In particular, the growth potential of multi-modal artificial intelligence systems for processing various big data such as video, audio and image has been attracting attention recently, and research on this is being actively conducted. The multi-modal artificial intelligence systems need to convert big data into formats that can be processed by artificial intelligence, and the demand for technologies for efficiently performing such conversion is increasing.

### SUMMARY

Embodiments of the present disclosure are directed to providing a system, a processing device and an operating method of the processing device, capable of efficiently executing an operation of pre-processing big data and an operation of transmitting pre-processed data, thereby shortening data processing delay time, easily constructing a data pipeline and improving energy efficiency.

Objects of embodiments of the disclosure are not limited to those set forth herein, and other unmentioned objects would be apparent to one of ordinary skill in the art from the following description.

In an embodiment, a system may include: a central processing unit; a first processing device including a first processor, a first base address register and a first memory; and a second processing device including a second processor, a second base address register and a second memory. The central processing unit may store, in the first base address register, pre-processing information that requests the first processing device to perform a pre-processing operation on original data stored in the first memory. The first processing device may read the original data from the first memory and execute pre-processing operation on the original data using the pre-processing information to generate result data, and may transmit the result data to the second processing device without intervention of the central processing unit.

In an embodiment, a processing device may include: a processor; a base address register; and a memory. The processor may read original data from the memory, read pre-processing information from the base address register, may execute a pre-processing operation on the original data using the pre-processing information to generate result data, and may transmit the result data directly to a target device external to the processing device.

In an embodiment, a method of operating a processing device may include: reading original data from the memory, reading pre-processing information from the base address register; executing a pre-processing operation on the original data using the pre-processing information to generate result data; and transmitting the result data directly to a external device.

According to embodiments of the present disclosure, it is possible to provide a system, a processing device and an operating method of the processing device, capable of efficiently executing an operation of pre-processing big data and an operation of transmitting pre-processed data, thereby shortening data processing delay time, easily constructing a data pipeline and improving energy efficiency.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a schematic configuration diagram of a system according to the present disclosure.

FIG. 2 is a diagram illustrating an operation in which a central processing unit according to the present disclosure stores pre-processing information in a first processing device.

FIG. 3 is a diagram illustrating an operation in which the first processing device according to the present disclosure generates result data.

FIG. 4 is a diagram illustrating an operation in which the central processing unit according to the present disclosure stores mapping information in the first processing device and a second processing device.

FIG. 5 is a diagram illustrating an example of the mapping information according to the present disclosure.

FIG. 6 is a diagram illustrating an operation in which the first processing device according to the present disclosure transmits the result data to the second processing device.

FIG. 7 is a diagram showing a method of operating a processing device according to the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present disclosure are described below in more detail with reference to the accompanying drawings. However, the present disclosure may be embodied in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

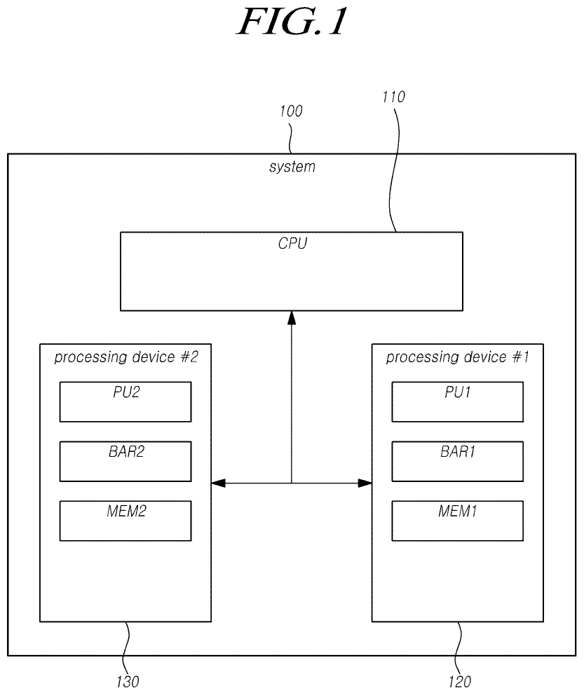

FIG. 1 is a schematic configuration diagram of a system 100 according to the present disclosure.

Referring to FIG. 1, the system 100 may include a central processing unit 110, a first processing device 120, and a second processing device 130.

The central processing unit 110 may control the first processing device 120 and the second processing device 130. The central processing unit 110 may perform a predefined logical computation to control the first processing device 120 and the second processing device 130. The central processing unit 110 may generate a command and a signal for controlling the first processing device 120 and the second processing device 130.

The central processing unit 110 may additionally include internal memory for storing data necessary to perform the aforementioned logical computation.

The first processing device 120 may include a first processor PU1, a first base address register BAR1, and a first memory MEM1.

The first memory MEM1 may be volatile or nonvolatile memory (e.g., SRAM, DRAM or NAND) capable of storing data.

The first base address register BAR1 is a register that stores memory mapping information between the first processing device 120 and the system 100. Through the memory mapping information stored in the first base address register BAR1, the first processing device 120 may transmit data to other devices (e.g., the second processing device 130) included in the system 100 directly, without intervention of the central processing unit 110 (i.e., in the absence of action taken by or participation from the central processing unit). A device that receives the data from the first processing device 120 may also be referred to as a target device. In detail, the first processing device 120 may transmit data through direct memory access (DMA) to other devices (e.g., the second processing device 130) included in the system 100.

The first base address register BAR1 may be a base address register that is defined in the Peripheral Component Interconnect Express (PCIe) standard.

The first processor PU1 may execute a computation on data stored in the first memory MEM1. For example, a computation to be executed by the first processor PU1 may be defined in firmware that is stored in the first memory MEM1. For another example, information on a computation to be executed by the first processor PU1 may be received from the central processing unit 110.

The first processing device 120 may be implemented in various ways. For example, the first processing device 120 may be a computational storage device capable of storing data and executing a computation on the stored data.

The second processing device 130 may include a second processor PU2, a second base address register BAR2, and a second memory MEM2.

The second processor PU2 may perform a computation (e.g., a graphics computation or a tensor computation) on data stored in the second memory MEM2. The second processor PU2 may be implemented by a GPU (Graphics Processing Unit), an APU (Accelerated Processing Unit), a DSP (Digital Signal Processor), an NPU (Neural Processing Unit), a TPU (Tensor Processing Unit), a hardware accelerator or a machine learning accelerator capable of memory mapping.

The second base address register BAR2 is a register that stores memory mapping information between the second processing device 130 and the system 100. Through the memory mapping information stored in the second base address register BAR2, the second processing device 130 may receive data from other devices (e.g., the first processing device 120) included in the system 100 directly, without intervention of the central processing unit 110 (i.e., in the absence of action taken by or participation from the central processing unit). In detail, the second processing device 130 may receive data through direct memory access (DMA) from other devices (e.g., the first processing device 120) included in the system 100.

Like the first base address register BAR1, the second base address register BAR2 may be a base address register that is defined in the Peripheral Component Interconnect Express (PCIe) standard.

The second memory MEM2 may store data necessary for the second processor PU2 to execute a computation. The second memory MEM2 may store data received from other devices (e.g., the first processing device 120) included in the system 100. For example, the second memory MEM2 may be volatile memory (e.g., SRAM).

The second processing device 130 may be implemented in various ways. For example, the second processing device 130 may be a processing device (e.g., a graphics processing device) capable of processing a plurality of computations (e.g., graphics computations) in parallel.

In embodiments of the present disclosure, the central processing unit 110, the first processing device 120 and the second processing device 130 may communicate with each other through a preset interface (e.g., PCIe). To this end, the system 100 may additionally include a communication device (e.g., a PCIe switch) that is connected to the central processing unit 110, the first processing device 120 and the second processing device 130.

Hereinbelow, the concrete operations of the central processing unit 110, the first processing device 120 and the second processing device 130 will be described.

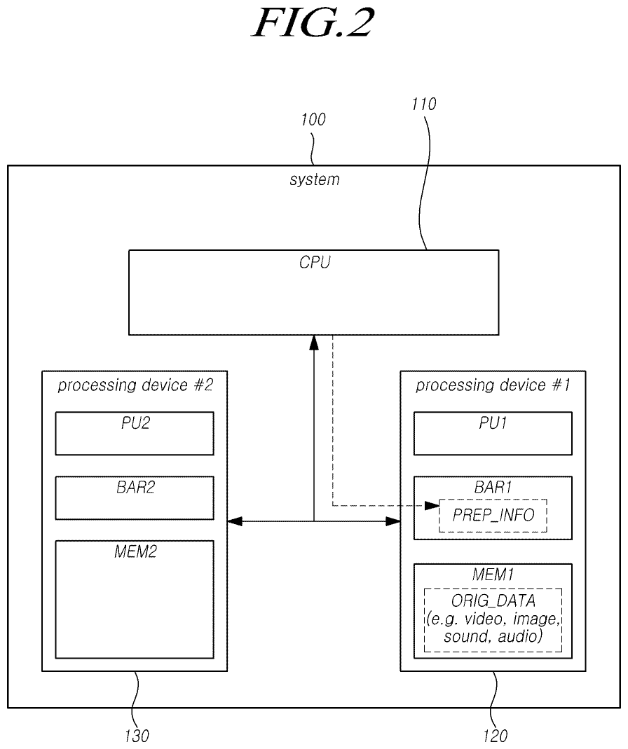

FIG. 2 is a diagram illustrating an operation in which the central processing unit 110 according to the present disclosure stores pre-processing information PREP_INFO in the first processing device 120.

Referring to FIG. 2, the central processing unit 110 may store pre-processing information PREP_INFO in the first base address register BAR1. That is to say, by storing the memory mapping information for DMA and the pre-processing information PREP_INFO for a pre-processing operation together in the first base address register BAR1, the central processing unit 110 enables the first processing device 120 to perform the pre-processing operation.

The pre-processing information PREP_INFO is information that requests the first processing device 120 to perform the pre-processing operation on original data ORIG_DATA stored in the first memory MEM1.

In embodiments of the present disclosure, the pre-processing operation on the original data ORIG_DATA means an operation of converting the original data ORIG_DATA from its original format into a different format (e.g., a vector) to make the original data ORIG_DATA suitable for a given computation (e.g., an artificial intelligence computation).

For example, when the original data ORIG_DATA is data that is encoded into a video format (e.g., H264 or mpeg), the pre-processing operation on the original data ORIG_DATA may be an operation of decoding and converting the original data ORIG_DATA into a preset format.

The central processing unit 110 may process metadata for the original data ORIG_DATA to generate the pre-processing information PREP_INFO and then store the pre-processing information PREP_INFO in the first base address register BAR1.

The original data ORIG_DATA and the pre-processing information PREP_INFO may be implemented in various ways.

For example, the original data ORIG_DATA may be unstructured data. The unstructured data is data that has no predefined structure and is therefore not structured. In embodiments of the present disclosure, the type of the original data ORIG_DATA may be video, image, sound, audio, etc.

Due to the characteristics of unstructured data, an artificial intelligence model that uses the unstructured data requires a process of pre-processing the unstructured data.

For example, the pre-processing information PREP_INFO may be semi-structured data. The semi-structured data is data that includes together target data and structural information (e.g., a tag or a marker) on the target data. In embodiments of the present disclosure, the pre-processing information PREP_INFO may include the location of the original data ORIG_DATA and metadata (e.g., resolution, bit rate and the number of frames per second) for the original data ORIG_DATA.

Therefore, through the structural information included in the semi-structured data, the first processing device 120 may check a pre-processing operation indicated by the pre-processing information PREP_INFO.

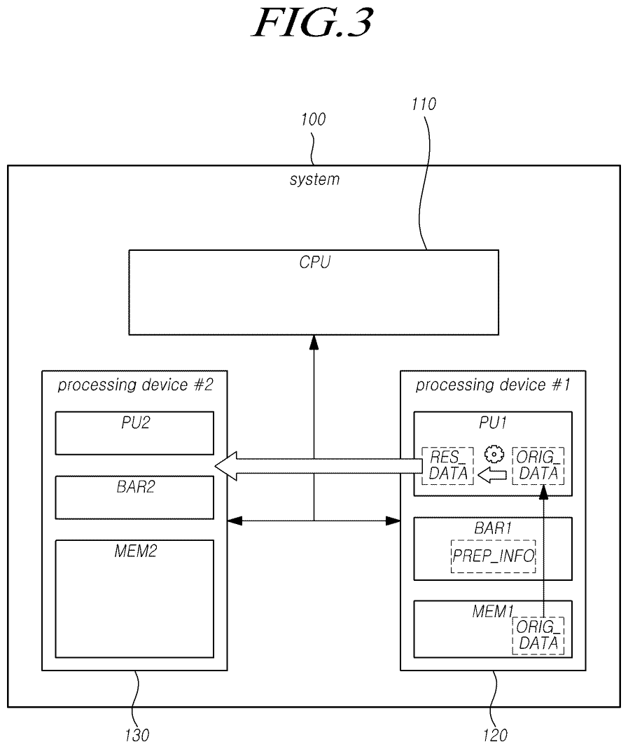

FIG. 3 is a diagram illustrating an operation in which the first processing device 120 according to the present disclosure generates result data RES_DATA.

Referring to FIG. 3, the first processor PU1 may detect that the central processing unit 110 has stored the pre-processing information PREP_INFO in the first base address register BAR1. The first processor PU1 may perform the pre-processing operation on the basis of the detected pre-processing information PREP_INFO. Through the pre-processing information PREP_INFO, the first processor PU1 may obtain authority to pre-process the original data ORIG_DATA from the central processing unit 110.

For example, the central processing unit 110 may store the pre-processing information PREP_INFO in a target field that is preset in the first base address register BAR1. When the target field of the first base address register BAR1 is found to have a preset value, the first processor PU1 determines that the pre-processing information PREP_INFO, which is transmitted from the central processing unit 110, is stored in the first base address register BAR1.

For another example, when the data, which is written to the first base address register BAR1 by the central processing unit 110, is found to have a preset threshold value in size, the first processor PU1 determines that the pre-processing information PREP_INFO is stored in the first base address register BAR1.

For still another example, after storing the pre-processing information PREP_INFO in the first base address register BAR1, the central processing unit 110 is designed to transmit, to the first processor PU1, a command or signal indicating that the pre-processing information PREP_INFO has been stored in the first base address register BAR1. Upon receiving the command or signal, the first processor PU1 determines that the pre-processing information PREP_INFO is stored in the first base address register BAR1.

The first processor PU1 may execute a computation of pre-processing the original data ORIG_DATA on the basis of the pre-processing information PREP_INFO stored in the first base address register BAR1 to generate result data RES_DATA.

The result data RES_DATA may be implemented in various ways. For example, the result data RES_DATA may be structured data. The structured data is data that is stored according to a predetermined structure and format.

The first processing device 120 may transmit the result data RES_DATA to the second processing device 130.

As described above, according to the present invention, the operation of pre-processing the original data ORIG_DATA can be performed in the first processing device 120, without involving the central processing unit 110 (i.e., in the absence of action taken by or participation from the central processing unit).

In contrast, according to a conventional data processing system, the pre-processing operation is performed by a central processing unit, and a bottleneck phenomenon may occur. For example, a bottleneck issue may occur while the original data ORIG_DATA stored in the first processing device is transmitted to the central processing unit.

In another example, a bottleneck issue may further occur while the central processing unit performs a pre-processing operation and then transmits the result of the pre-processing operation back to the first processing device.

As such, when the conventional data processing system is employed, a data pipeline becomes complicated in a process of pre-processing the original data ORIG_DATA and of transmitting the result of the pre-processing operation. In addition, unnecessary data transmission overhead occurs because the central processing unit is required to maintain all data pipelines. As a result, system performance significantly deteriorates.

According to an embodiment of the present disclosure, (i) the pre-process operation of the original data ORIG_DATA and then (ii) the transmission operation of the result data RES_DATA to the second processing device 130 are performed by the first processing device 120. Put it another way, (i) the pre-process operation of the original data ORIG_DATA and (ii) the transmission operation of the result data RES_DATA to the second processing device 130 are performed without intervention of the central processing unit 110 (i.e., in the absence of action taken by or participation from the central processing unit). Since involvement of the central processing unit 110 is minimized or absent during the pre-process operation and the transmission operation of the result data RES_DATA, data transmission overhead can be reduced, and as a result, overall performance of the system 100 can be improved.

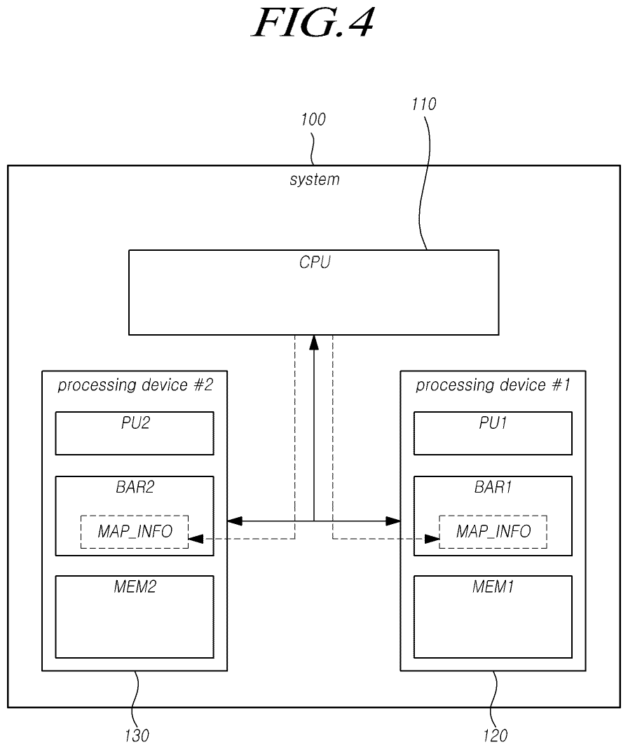

FIG. 4 is a diagram illustrating an operation in which the central processing unit 110 according to the present disclosure stores mapping information MAP_INFO in the first processing device 120 and the second processing device 130.

Referring to FIG. 4, the central processing unit 110 may store mapping information MAP_INFO in the first base address register BAR1 of the first processing device 120 and the second base address register BAR2 of the second processing device 130.

The mapping information MAP_INFO may indicate the mapping between a memory space corresponding to the first processing device 120 and a memory space corresponding to the second processing device 130. Accordingly, through the mapping information MAP_INFO, memory mapping between the first processing device 120 and the second processing device 130 is possible, and data transmission and reception through direct memory access (DMA) is possible.

Under this structure, the central processing unit 110 does not participate in the data transmission and reception process between the first processing device 120 and the second processing device 130.

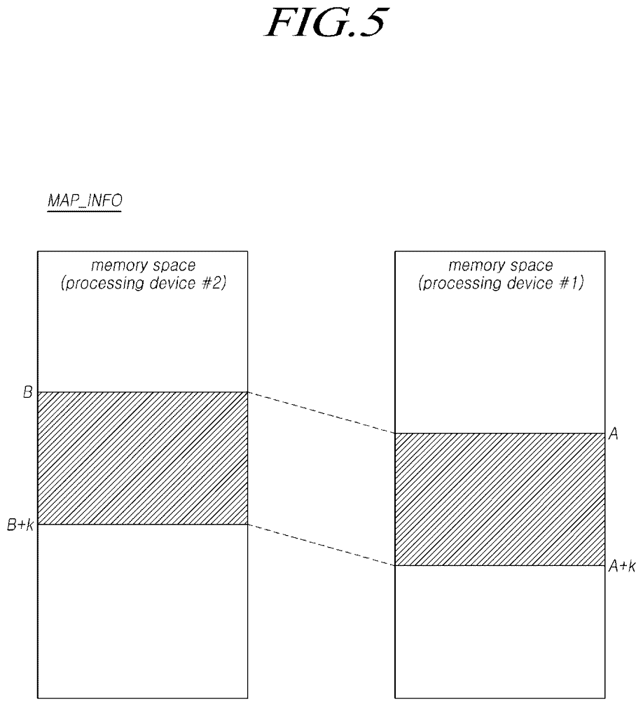

FIG. 5 is a diagram illustrating an example of the mapping information MAP_INFO according to the present disclosure.

The mapping information MAP_INFO may indicate that a section A to (A+k) of the memory space of the first processing device 120 is mapped to a section B to (B+k) of the memory space of the second processing device 130.

Accordingly, by writing data to the section A to (A+k), the first processing device 120 may transmit data to the second processing device 130 through DMA.

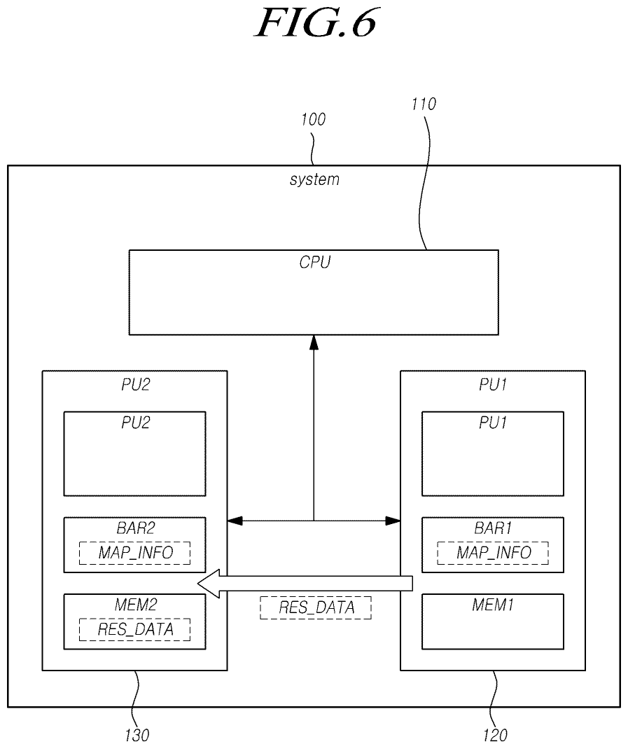

FIG. 6 is a diagram illustrating an operation in which the first processing device 120 according to the present disclosure transmits the result data RES_DATA to the second processing device 130.

Referring to FIG. 6, the first processing device 120 may transmit the result data RES_DATA to the second processing device 130 through direct memory access (DMA) using the mapping information MAP_INFO. Through this, the first processing device 120 and the second processing device 130 may configure a data pipeline without intervention of the central processing unit 110 (i.e., in the absence of action taken by or participation from the central processing unit).

The second processing device 130 may store the result data RES_DATA in the second memory MEM2. The second processor PU2 of the second processing device 130 may perform a predefined computation using the result data RES_DATA stored in the second memory MEM2.

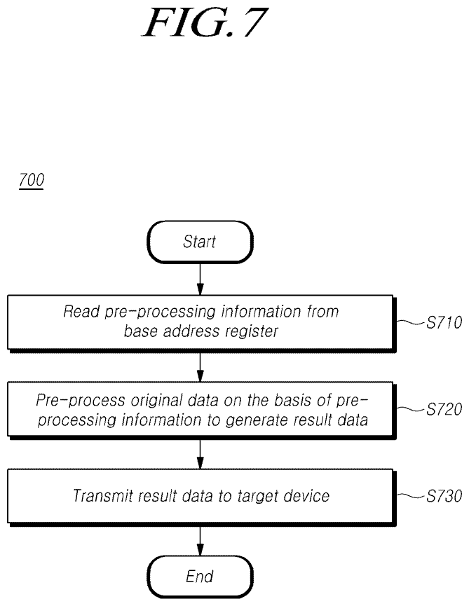

FIG. 7 is a diagram showing a method 700 of operating a processing device according to the present disclosure.

The processing device may include a processor, a base address register and a memory.

The method 700 of operating the processing device may include a step S710 of reading, from the base address register, pre-processing information that requests a pre-processing operation on original data stored in the memory.

The method 700 of operating the processing device may include a step S720 of pre-processing the original data on the basis of the pre-processing information to generate result data.

For example, the original data may be unstructured data, and the result data may be structured data.

For example, the pre-processing information may be semi-structured data.

The method 700 of operating the processing device may include a step S730 of transmitting the generated result data to a target device.

The step S730 may transmit the result data to the target device by performing a direct memory access (DMA) operation using mapping information stored in the base address register. The mapping information may indicate mapping between a memory space corresponding to the processing device and a memory space for the target device.

The processing device may be the first processing device 120 described above with reference to FIG. 1. The processor may be the first processor PU1, the base address register may be the first base address register BAR1, and the memory may be the first memory MEM1.

The target device may be the second processing device 130 described above with reference to FIG. 1.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A system comprising:
a central processing unit;
a first processing device including a first processor, a first base address register and a first memory; and
a second processing device including a second processor, a second base address register and a second memory,
wherein the central processing unit stores, in the first base address register, pre-processing information that requests the first processing device to perform a pre-processing operation on original data stored in the first memory, and
wherein the first processing device reads the original data from the first memory and executes a pre-processing operation on the original data using the pre-processing information to generate result data, and
wherein the first processing device transmits the result data to the second processing device without intervention of the central processing unit.

2. The system according to claim 1, wherein
the first processing device is a computational storage device capable of storing data and executing a computation on the stored data, and the second processing device is a processing device capable of processing a plurality of computations in parallel.

3. The system according to claim 1,
wherein the original data is unstructured data,
wherein the result data is structured data.

4. The system according to claim 3,
wherein the pre-processing information is semi-structured data.

5. The system according to claim 1,
wherein, when a preset target field of the first base address register has a preset value, the first processor determines that the pre-processing information is stored in the first base address register.

6. The system according to claim 1, wherein
the central processing unit stores mapping information indicating mapping between a memory space corresponding to the first processing device and a memory space corresponding to the second processing device, in the first base address register and the second base address register, and
the first processing device transmits the result data to the second processing device by performing a DMA (Direct Memory Access) operation using the mapping information.

7. A processing device comprising:
a processor;
a base address register;
and a memory,
wherein the processor reads original data from the memory, reads pre-processing information from the base address register, executes a pre-processing operation on the original data using the pre-processing information to generate result data, and transmits the result data directly to a target device external to the processing device.

8. The processing device according to claim 7,
wherein the original data is unstructured data, wherein the result data is structured data.

9. The processing device according to claim 8,
wherein the pre-processing information is semi-structured data.

10. The processing device according to claim 7,
wherein mapping information is commonly stored in each of the base address register and the target device,
wherein the processor transmits the result data to the target device by performing a DMA (Direct Memory Access) operation using the mapping information.

11. A method of operating a processing device comprising:
providing a processor, a base address register and a memory in the processing device;
reading original data from the memory,
reading pre-processing information from the base address register,
executing a pre-processing operation on the original data using the pre-processing information to generate result data, and
transmitting the result data directly to an external device.

12. The method according to claim 11,
wherein the original data is unstructured data, and
wherein the result data is structured data.

13. The method according to claim 12,
wherein the pre-processing information is semi-structured data.

14. The method according to claim 11, wherein
the transmitting the result data to the external device transmits the result data to the external device by performing a DMA (Direct Memory Access) operation using mapping information stored in the base address register, and
the mapping information indicates mapping between a memory space corresponding to the processing device and a memory space corresponding to the external device.
